(19) United States
(12) Patent Application Publication
(10) Pub. No.: US 2015/0185674 A1
(43) Pub. Date: Jul. 2, 2015

(54) IMAGE FORMING APPARATUS AND PRINT POSITION ADJUSTMENT METHOD

(71) Applicant: Kyocera Document Solutions Inc., Osaka (JP)

(72) Inventor: Yasuhiro IWASHIMA, Osaka (JP)

(73) Assignee: KYOCERA Document Solutions Inc., Osaka (JP)

(21) Appl. No.: 14/581,596

(22) Filed: Dec. 23, 2014

(30) Foreign Application Priority Data
Dec. 27, 2013 (JP) 2013-271850

(51) Int. Cl. G03G 15/00

(52) U.S. Cl. CPC G03G 15/5062; B65H 1/28; B65H 7/20

(57) ABSTRACT

The print pattern forming unit forms plural comparative print patterns on a sheet by reference print patterns corresponding to every sheet feed cassette associated with different reference positions for every sheet feed cassette. The displacement amount calculation unit reads the comparative print patterns on the sheet, and calculates displacement amounts between the reference positions and comparative positions of the read comparative print patterns corresponding to the reference positions. The correction unit corrects the print position of the sheet conveyed from the sheet feed cassette based on the displacement amount for every sheet feed cassette.

### CROSS-REFERENCE TO RELATED APPLICATION

This application claims the benefit of priority to Japanese Patent Application No. 2013-271850 filed on Dec. 27, 2013, the entire contents of which are incorporated by reference herein.

### BACKGROUND OF THE INVENTION

The present disclosure relates to an image forming apparatus and a print position adjustment method.

With respect to the image forming apparatus such as the multifunction peripheral and the copying machine, there are many conventional techniques for adjusting a sheet position of a conveyed sheet to an image forming position of an image to be formed.

An image forming apparatus includes an end detection unit that is provided to a printing unit and detects a top and sides of a recording sheet. This apparatus is configured to move the printing unit toward the main-scanning direction and the sheet toward the sub-scanning direction respectively in a predetermined timing according to a signal detected by the end detection unit, and then form the image on the sheet. The apparatus further includes an image forming position adjustment unit for moving the printing unit toward the main-scanning direction before the end detection unit detects both sides of the sheet after detecting the top of the sheet before the printing. The image forming position adjustment unit detects a specific position of the recording sheet and adjusts the image forming position on the recording sheet according to the specific sheet position. According to such configuration, it is possible to change the image forming position according to the sheet position of the conveyed recording sheet, so that the registration alignment can be realized by a simple structure. Therefore, it is possible to obtain effects that the image is formed a predetermined position and the image quality is stabilized.

The other image forming apparatus is configured to adjust the print position of a sheet conveyance direction for a toner image on a recording sheet supplied from a reference sheet feed cassette, when the image forming apparatus is inspected before the factory shipment. In this image forming apparatus, a reference time is found, the reference time is a time till a recording sheet top detecting sensor detects the top of the recording sheet after a pair of resist rollers starts the conveyance of the recording sheet. Moreover, when the image forming apparatus is working in use of a user, with respect to the recording sheet fed from an arbitrary sheet cassette, a time till the recording sheet top detecting sensor detects the top of the recording sheet after the pair of resist rollers starts the conveyance of the recording sheet is found as a comparative time. The apparatus is configured to correct a reference image forming time that is predetermined based on a difference between the reference time and the comparative time (for example, a time till the recording sheet is ejected after the resist rollers start the feeding of the recording sheet). Hereby, regardless the number of the sheet feed cassettes and the kind of the sheet, it is possible to correct properly the print position of the toner image on the sheet by a simple setting operation.

When an original is copied by a multifunction peripheral, it is requested to accord a specific position on the original with a corresponding position on a printed matter. When a displacement of the two positions appears, it means that there is a trouble in the start timing of feeding the sheet by a pair of resist rollers, or the displacement for every sheet feed cassette (in particular, the displacement of the main scanning direction by an image forming unit). Accordingly, in order to accord the specific position of the original and the corresponding position of the printed matter, the start timing of feeding the sheet by the pair of resist rollers or the print start timing of the main scanning direction and the sub scanning direction by the image forming unit must be adjusted at the factory shipment, and they must be also adjusted when the displacement appears in use of the user.

The conventional print position adjustment method is executed as follows, for example. When the user operates the print position adjustment using a specific sheet feed cassette, a pattern for the print position adjustment is printed on a sheet conveyed from the specific sheet feed cassette and the user measures the print position on the sheet manually. Otherwise, after the sheet on which the pattern for the print position adjustment is printed is read by an image reading unit like the scanners, the print position is measured based on the read image data. And then, the user compares the measured print position with the print position to be desired, and the displacement amount is calculated. In order not to produce the displacement, the print timing is adjusted.

In the conventional print position adjustment method, however, the sheet printed with the print position adjustment pattern is to be printed for each sheet feed cassette, and the print position is to be measured for each sheet. Therefore, in case of the image forming apparatus having a plurality of sheet feed cassettes, there are problems that the adjustment operation needs a great deal of time and is very troublesome. In addition, since the sheet printed with the print position adjustment pattern is always disposed after the print position is measured, there is a problem that the sheet is useless. The techniques in the above disclosures cannot resolve such problems.

### BRIEF SUMMARY OF THE INVENTION

According to one aspect of the present disclosure, an image forming apparatus includes a plurality of sheet feed cassettes, a print pattern forming unit, a displacement amount calculation unit, and a correction unit.

The print pattern forming unit forms plural comparative print patterns on a sheet by reference print patterns corresponding to every sheet feed cassette associated with different reference positions for every sheet feed cassette.
a. The displacement amount calculation unit reads the comparative print patterns on the sheet, and calculates displacement amounts between the reference positions and comparative positions of the read comparative print patterns corresponding to the reference positions.

The correction unit corrects the print position of the sheet conveyed from the sheet feed cassette based on the displacement amount for every sheet feed cassette.

The print pattern forming unit radially prints the comparative print patterns corresponding to every sheet feed cassette on one sheet. The reference print patterns and the comparative print patterns are in V-shape having specific angles, and opening directions of the angle based on a sheet conveyance direction correspond to every sheet feed cassette.

When the print pattern forming unit forms a comparative print pattern for a specific sheet feed cassette on one sheet and then forms the other comparative print pattern for the other sheet feed cassette on the same sheet, the print pattern forming units reversely conveys the sheet to the other sheet feed cassette and stores the sheet in the other cassette, and conveys the sheet from the other cassette, and forms the other comparative print pattern on the sheet.

When the print pattern forming unit forms a comparative print pattern for a specific sheet feed cassette on one sheet and then forms the other comparative print pattern for the other sheet feed cassette on the sheet, the print pattern forming units ejects the sheet to a sheet receiving tray, displays an instruction to place the ejected sheet to the other sheet feed cassette, and detects the sheet is placed in the other cassette and then forms the other comparative print pattern on the sheet.

Moreover, the print pattern forming unit selects a V-shaped reference print pattern of a specific angle with respect to the sheet conveyance direction of the sheet corresponding to a specific sheet feed cassette among the reference print patterns stored in a storage device, and forms the comparative print pattern by printing the selected reference print pattern on the sheet. The displacement amount calculation unit calculates the comparative position of the specific comparative print pattern of the read plural comparative print patterns, and determines the reference print patter having the approximately same angle as the direction of the opening angle of the comparative print pattern, and calculates, as the displacement amount of the comparative print pattern, a difference when the reference position of the determined reference print pattern is subtracted from the calculated comparative position of the comparative print pattern.

### BRIEF DESCRIPTION OF THE SEVERAL VIEWS OF THE DRAWINGS

These and/or other aspects and advantages of the invention will become apparent and more readily appreciated from the following description of the embodiments, taken in conjunction with the accompanying drawings of which:

FIG. 1 is a schematic view of a multifunction peripheral in accordance with an embodiment of the present disclosure.

FIG. 2 is a conceptual view showing a whole structure of an operation unit in accordance with an embodiment of the present disclosure.

FIG. 3 is a block diagram showing control system hardware of the multifunction peripheral in accordance with an embodiment of the present disclosure.

FIG. 4 is a functional block diagram of the multifunction peripheral in accordance with an embodiment of the present disclosure.

FIG. 5 is a flowchart indicating execution steps of the present disclosure.

FIG. 6A is a view indicating an example of image data for print pattern in accordance with an embodiment of the present disclosure.

FIG. 6B is a view indicating an example of image data on a sheet printed with a plurality of print patterns in accordance with an embodiment of the present disclosure.

### DETAILED DESCRIPTION OF THE INVENTION

According to attached drawings, embodiments of the image forming apparatus in the present disclosure are explained hereinafter in order to understand the present disclosure. Besides, the following embodiment is only an example that realizes the present disclosure, and does not limit the technical scope of the present disclosure. Additionally, the alphabet “S” in front of a numeral in the flowchart means a “step”.

### Image Forming Apparatus

The image forming apparatus including the plurality of sheet feed cassettes is explained hereinafter as the image forming apparatus in accordance with the embodiments of the present disclosure. The parts that do not have direct connection to the present disclosure are explained briefly and the details are omitted. The image forming apparatus in the present disclosure corresponds to a multifunction peripheral provided with functions of a copying machine, a scanner and a printer, which functions as the image forming apparatus having a copy function, a scanner function and a print function.

When the user uses the copy function, the working of the multifunction peripheral 100 (MFP) is explained hereinafter briefly.

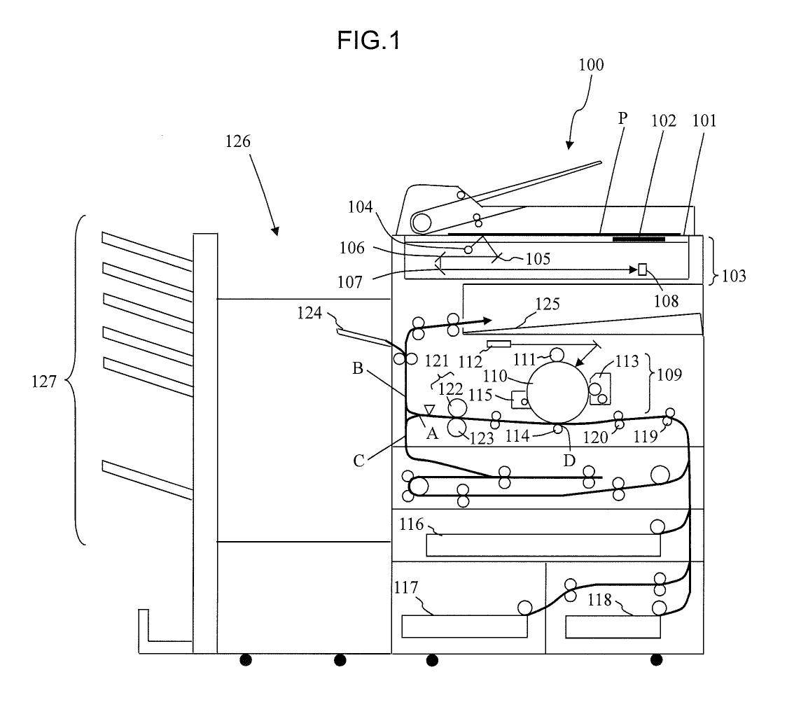

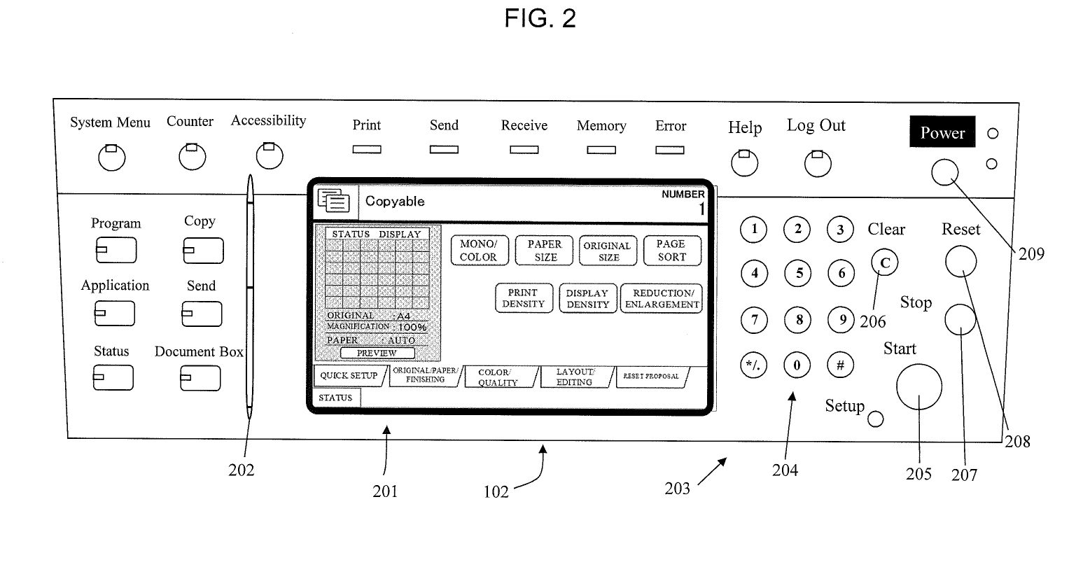

As shown in FIG. 1, when the user performs the copying by the multifunction peripheral 100, first, the user puts an original P on an original plate 101 on a top of the multifunction peripheral 100 and inputs the setting of the copy function from an operation unit 102. In addition, the user presses down a start key 205 on the operation unit 102 (see FIG. 2) and let the multifunction peripheral 100 start the printing.

At the beginning of the printing process, the multifunction peripheral 100 starts reading an image of the original P. First, in an image reading unit 103, the light emitted from a light source 104 is reflected on a surface of the original P placed on the original plate 101. The reflected light is guided to an imaging element 108 by mirrors 105, 106 and 107. The guided light is photo-electrically converted by the imaging element 108, and read as an image data. The read image data is transferred to a recording medium (e.g. a recording paper, or a sheet) by an image forming unit 109.

The image forming unit 109 is provided with a photosensitive drum 110. The photosensitive drum 110 rotates in a predetermined direction at a fixed speed. Around the photosensitive drum 110, a charging unit 111, an exposing unit 112, a developing unit 113, a transfer unit 114, and a cleaning unit 115 are arranged in order from the upstream side of the rotation direction

The charging unit 111 electrifies a surface of the photosensitive drum 110 uniformly. The exposing unit 112 irradiates the laser beam on the surface of the electrified photosensitive drum 110 according to the image data of the original P, and forms an electrostatic latent image. The developing unit 113 sticks the toner on the formed electrostatic latent image, and forms a toner image. The formed toner image is transferred to a sheet by the transfer unit 114. The cleaning unit 115 removes excessive toner remained on the surface of the photosensitive drum 110. This series of process is executed whenever the photosensitive drum rotates.

The sheet is supplied from a polarity of sheet feed cassettes, such as an upper cassette 116, a bottom left cassette 117, or a bottom right cassette 118, and each cassette stores a different size of sheet. When the sheet is conveyed, a pickup roller pulls the sheet out to a conveyance path from one of the sheet feed cassettes 116, 117, and 118. The sheet feed cassette 116, 117, or 118, from which the sheet is pulled out, is decided based on the setting that the user has inputted to the operation unit 102.

The sheet pulled to the conveyance path is sent to a transfer point D between the photosensitive drum 110 and the transfer unit 114 by conveyance rollers 119 and resist rollers 120, the toner image based on the image data of the original P is transferred to the sheet, and then the sheet is conveyed to a fixing unit 121.

When the sheet on which the toner image is transferred is passing between a heat roller 122 and a pressure roller 123, which are provided to the fixing unit 121, the toner image is fixed on the sheet by applying the heat and pressure on the toner image. The quantity of heat of the heat roller 122 is predetermined optimally depending on the kind of sheet, and the fixing is executed appropriately. The sheet on which the toner image is fixed is stored in a copy receiving tray 124 through a conveyance path B.

The present disclosure can be applied to an image forming apparatus including the duplex printing structure as described below, and the explanation about the duplex printing is made briefly. The sheet after the fixing is conveyed from the fixing unit 121 to a specific junction A. The junction A is connected with the conveyance path B for conveying the sheet to the copy receiving tray 124 and a duplex printing conveyance path C for the duplex printing.

In case where the duplex printing is selected, the sheet is guided to the duplex printing conveyance path C, reversed, and conveyed to the transfer point D between the photosensitive drum 110 and the transfer unit 114. While the sheet is conveyed to the transfer point D, the image (for a back of the sheet) is formed on the photosensitive drum 110 based on the toner image formed on the photosensitive drum 110.

After the toner image has been transferred to the back of the sheet, the transferred sheet is conveyed to the fixing unit 121 again, and the fixing is executed. After the fixing, the duplex-printed sheet is sent from the junction A to the convey path B guiding to the copy receiving tray 124, and then loaded on and stored in the copy receiving tray 124.

The copy receiving tray 124 is provided on a side of the multifunction periphery 100, and a tray 125 is built in housing of the multifunction peripheral 100. According to the setting by the user from the operation units 102, the sheet after the fixing may be loaded on the tray 125.

After detaching the sheet receiving tray 124, an external finisher 126 can be connected with the side of the multifunction peripheral 100. In such case, the printed sheet can be ejected to any of the plural trays provided to the external finisher 127. According to the above procedure, the multifunction peripheral 100 can provide the user with the copy function.

As shown in FIG. 2, the user inputs the setting conditions as above and confirms the inputted setting conditions by means of the operation unit 102. When the setting condition is inputted, the user uses a touch panel 201 (an operation panel), a touch pen 202, and an operation key 203 that are provided to the operation unit 102.

The touch panel 201 includes both a function of inputting the setting condition and a function of displaying a setting condition. That is, when the user presses down the key on a screen displayed on the touch panel 201, the setting condition corresponding to the pressed key is inputted.

A display unit (not shown) such as LCD (Liquid Crystal Display) is provided on a back of the touch panel 201. The display unit displays an operation screen, such as an initial screen, for example. The touch pen 202 is provided nearby the touch panel 201, and when the user contacts the touch panel 201 with a tip of the touch pen 202, a sensor under the touch panel 201 detects the contact of the tip.

Nearby the touch panel 201, a specific number of operation keys 203 are arranged, such as a ten key 204, a start key 205, a clear key 206, a stop key 207, a reset key 208, and a power key 209, for example.

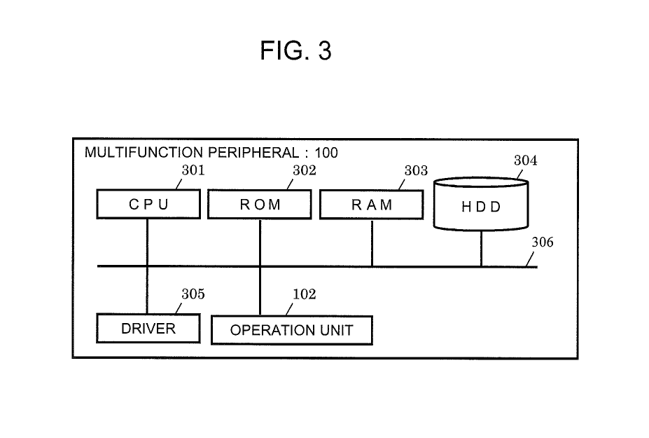

With reference to FIG. 3, the structure of the control system hardware of the multifunction peripheral 100 is explained here. The parts that do not have direct relation to the present disclosure are explained briefly, and the details are omitted.

A control circuit of the multifunction peripheral 100 is configured to connect CPU (Central Processing Unit) 301, ROM (Read Only Memory) 302, RAM (Random Access Memory) 303, HDD (Hard Disk Drive) 304, a driver 305 corresponding to each driving unit, and an operation unit 102 through an internal bus 306.

The CPU 301 uses the RAM 303 as a working area, for example, and executes programs stored in the ROM 302 and the HDD 304, receives data, instructions, signals and commands sent from the operation unit 102 according to the execution result, and controls the operation of each driving unit shown in FIG. 1 by driving the driver 305.

### Embodiment of the Present Invention

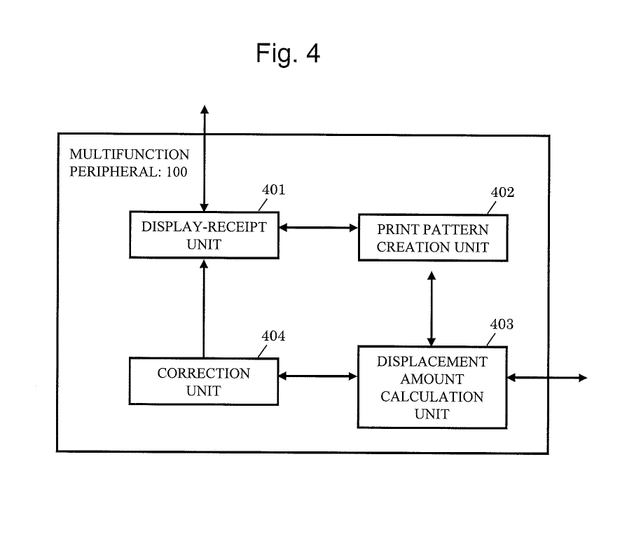

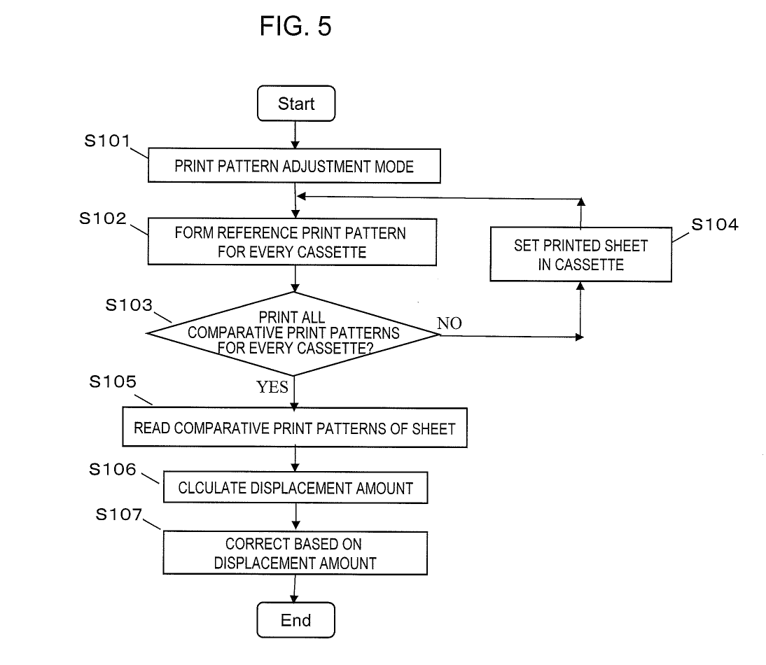

With referring to FIG. 4 and FIG. 5, the present disclosure for adjusting the position displacement is explained in accordance with embodiments of the present disclosure. Besides, it is assumed in the under-mentioned explanation that the multifunction peripheral of the present disclosure includes an upper cassette 116, a bottom left cassette 117, a bottom right cassette 118, and, in case where a sheet conveyance path for the duplex printing is considered as a virtual sheet feed cassette, there are four kinds of sheet feed cassettes, and each cassette stores a same size of sheet.

Besides, provided that each of the upper cassette 116, the bottom left cassette 117, and a bottom right cassette 118 is further provided with the virtual sheet feed cassette respectively, any correction is made for the influences of the displacement amount of each sheet feed cassette on the back of the sheet. In such case, it is assumed that there are six kinds of sheet feed cassettes, and the processing is performed in the same manner as described hereinafter.

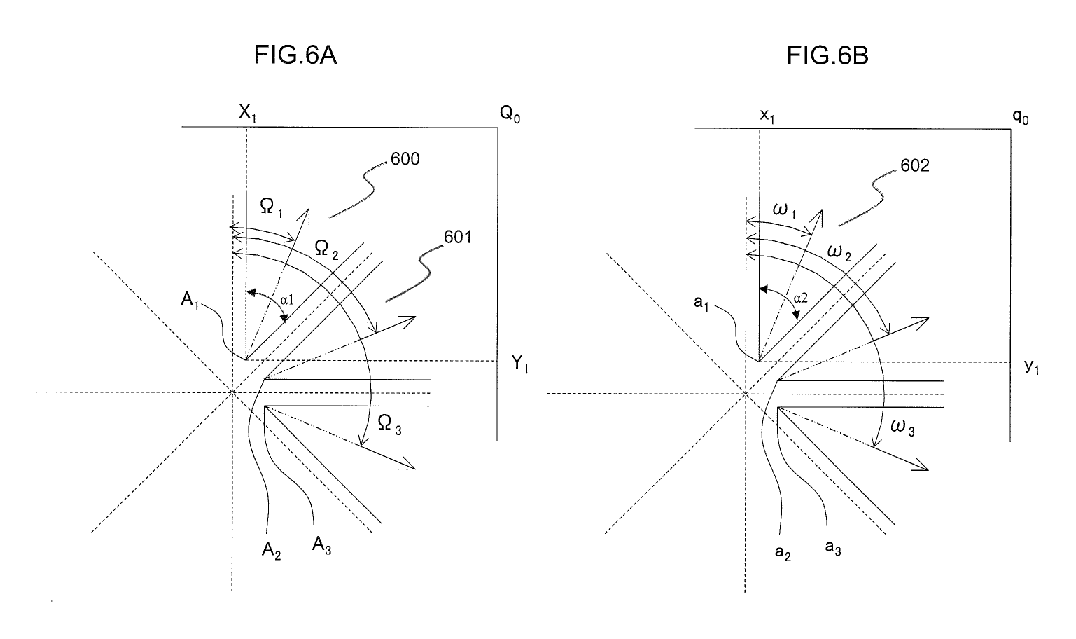

A print pattern forming unit (described later) provided to the multifunction peripheral includes a storage device that has stored plural reference print patterns corresponding to respective sheet feed cassettes in advance (before the factory shipment). Each reference print pattern is in a V-shape opening a specific angle α1, and disposed radially, as shown in FIG. 6A. Points A1, A2, A3 . . . of the V-shapes are reference print positions of the sheets conveyed from respective sheet feed cassettes, and opening directions Ω1, Ω2, Ω3 . . . of the V-shapes based on the sheet conveyance direction (a direction of a line connecting a center expanding radially and the reference print position) correspond to respective sheet feed cassettes. The reference print positions can be expressed by the XY coordinates (A1: X1, Y1; A2: X2, Y2; A3: X3, Y3 . . . ) in the coordinate system with an origin located at a specific position of a print area (an upper right corner Q0).

Here, the user executes the print position adjustment of the multifunction peripheral 100 according to following steps. First, the user operates the keys to change to a system screen and presses the print position adjustment key (not shown). In response to the press of the print position adjustment key, a display-receipt unit 401 changes from a normal mode to a print position adjustment mode (FIG. 5: S101). The display-receipt unit 401 receives inputs by the user.

The display-receipt unit 401 notifies a print pattern forming unit 402 of the mode change. Upon receipt of the notice, the pattern forming unit 402 forms a comparative print pattern by the reference print patterns stored in the storage device on one sheet.

That is to say, the print pattern forming unit 402 specifies a specific sheet feed cassette (e.g. the upper cassette), refers to the plural reference print patterns stored in the storage device, and selects a reference print pattern corresponding to the specified sheet feed cassette (the upper cassette 116: the angle Ω1) among the plural reference print patterns. In addition, the print patter forming unit 402 conveys the sheet from the upper cassette 116 and forms the reference print pattern corresponding to the upper cassette 116 on the sheet (FIG. 5: S102), and sends the sheet from the fixing unit 121. Accordingly, the comparative print pattern corresponding to the upper cassette 116 is printed on the sheet.

Furthermore, the print pattern forming unit 402 determines whether or not all the comparative print patterns for every sheet feed cassette have been formed on this sheet (FIG. 5: S103). Since the all the comparative print patterns for every sheet feed cassette has not been formed on the sheet in this case (FIG. 5: S103 NO), the print pattern forming unit 402 specifies another sheet feed cassette for which the comparative print pattern was not formed (e.g. the lower left cassette 117).

Next, the print pattern forming unite 402 reversely conveys the sheet sent from the fixing unit 121 to the specific position (e.g. the junction A) to the specified lower left cassette 117 by rotating the conveyance roller 119 reversely, and then stored the sheet in the lower left cassette 117 (FIG. 5: S104).

And then, the print pattern forming unit 402 selects the reference print pattern 601 (an angle Ω2) corresponding to the lower left cassette 117 among the stored reference print patterns, conveys the sheet stored in the lower left cassette 117, and forms the comparative print pattern corresponding to the lower left cassette 117 on the sheet (FIG. 5: S102). It is possible to print the comparative print patterns for every sheet feed cassette on the sheet by repeating the above steps for every sheet feed cassette (S102 to S103 to S104).

It is sure that the comparative print patterns for every sheet feed cassette are printed radially on the sheet, but where the displacement occurs, the comparative print patterns appears in slightly different manner from the reference print patterns shown in FIG. 6A. That is, the opening angle of the V-shape becomes α2, and points (comparative positions; explained later) corresponds to the reference positions A1, A2, A3 . . . become points a1, a2, a3 . . . In addition, the opening directions of the V-shapes (the direction connecting the center expanding radially and the comparative position) becomes ω1, ω2, ω3 . . . corresponding to the angles Ω1, Ω2, Ω3 . . . Since the printing area is affected by such displacement, the points α1, α2, α3 . . . are expressed by the xy coordinates, a1: x1, y1; a2: x2, y2; a3: x3, y3 in the coordinate system with an origin q0 instead of the origin Ω0. Here, case, the angles α1, α2 . . . have the same angle, and the angles Ω1, Ω2, Ω3 . . . are the same as the angles ω1, ω2, ω3 . . . , respectively. The position coordinates of the reference positions a1, a2, a3 . . . are different from the position coordinates of the comparative positions A1, A2, A3 . . .

When the cassette for feeing the sheet at the duplex printing is the virtual sheet feed cassette, the print pattern forming unit 402 conveys the printed sheet to the duplex printing conveyance path C. the print pattern forming unite 402 forms the comparative print pattern corresponding to the sheet conveyance at the duplex printing on the back of the sheet conveyed from the duplex printing conveyance path C.

Besides, the structure and the steps for forming on one sheet the comparative print patterns corresponding to plural sheet feed cassettes are not limited to the above structure and steps.

For instance, after printing a comparative print pattern corresponding to a sheet feed cassette on one sheet (FIG. 5: S102), the print pattern forming unit 402 ejects the sheet to the copy receiving tray 124 or the tray 125. The print pattern forming unit 402 displays on the display-receipt unit 401 to display an instruction to set the ejected sheet to the other sheet feed cassette, the cassette for which the print pattern is not formed. According to the instruction, the user places the ejected sheet in the other sheet feed cassette in manual (FIG. 5: S104). The print pattern forming unit 402 detects the placed sheet, and prints the comparative print pattern corresponding to the other sheet feed cassette on the sheet (FIG. 5: S102).

When all the comparative print patterns are formed on the sheet (FIG. 5: S103 YES), the print pattern forming unit 402 ejects the sheet to the copy receiving tray 124 or the tray 125, and notifies a displacement amount calculation unit 403 of the sheet ejection. Upon receipt of the notice, the displacement amount calculation unit 403 display on the display-receipt unit 40 a screen that the comparative print patterns on the ejected sheet is read.

At seeing the screen, the user places the ejected sheet, on which all the comparative print patterns are printed, on the original plate 101 and presses an image reading key. In response to the press of the key, the displacement amount calculation unit 403 reads the image of the sheet on which all the comparative print patterns are printed (the comparative print patterns) (FIG. 5, S105). The displacement amount calculation unit 403 calculates respective displacement amounts for every sheet feed cassette based on the reference positions of the reference print patterns and the comparative positions corresponding to the read comparative print patterns as follows (FIG. 5: S106).

The displacement amount calculation unit 403 specifies a comparative print pattern 602 having the angle ω1 of which the opening direction of the V-shape is the nearest to the angle Ω1 among the read comparative print patterns. The displacement amount calculation unit 403 calculates, as the comparative position of the comparative print pattern 602, the coordinates (x1, y1) of the point al of the V-shape of the specified comparative print pattern 602, in the coordinate system with the origin q0 located at the specific position (the upper right corner) of the print area of the read comparative print patterns. Next, the displacement amount calculation unit 403 calculates, as the displace amount of the comparative print pattern 602, a distance (ΔX=x1−X1, ΔY=y1−Y1) between the XY coordinates (X1, Y1) of the reference position A1 of the reference print pattern 600 and the xy coordinates (x1, y1) of the comparative position al of the comparative print pattern 602. Accordingly, the displacement amount calculation unit 403 can calculate the displacement amounts for every sheet feed cassette by repeating the above steps.

Besides, when the sheet is fed from the virtual sheet feed cassette at the duplex printing and the print pattern forming unit 402 forms the reference print pattern corresponding to the virtual sheet feed cassette, there is a possibility that the comparative print pattern corresponding to the cassette is printed on the back of the sheet. In such case, after reading the comparative print pattern on the front surface of the sheet on which the comparative print patterns are formed, the user subsequently places the back surface of the sheet on the original plate 101, and the comparative print pattern on the back surface of the sheet is read by pressing down the document reading key, and the above-mentioned steps are executed.

When the displacement amount calculation unit 403 complete the calculation of all the displacement amounts for every sheet feed cassette, the completion is notified to a correction unit 404. Upon receipt of the notice, the correction unit 404 corrects the print position of the sheet conveyed from the sheet feed cassette based on the displacement amount for every sheet feed cassette (FIG. 5: S107).

The correction unit 404 stores in the storage device the displacement amount of the comparative print pattern corresponding to the specific reference print pattern as the displacement amounts of the sheet feed cassettes corresponding to the print patterns.

When the multifunction peripheral 100 forms the toner image on the sheet from the specific sheet feed cassette next time, the correction unit 404 shifts the image forming position of the toner image by the displacement amount of the specific sheet feed cassette, in order not to displace the actual print position. Accordingly, even if the displacement amounts are different for every cassette, the print position on the sheet can be corrected by shifting the position of forming the toner image based on the calculated displacement amount. In addition, even if the sheet is conveyed from any sheet feed cassette, it is possible to form the toner image on an appropriate position. Besides the adjustment of the displacement amount means the adjustment for the sheet feeding speed, the adjustment of the timing of the sheet conveyance by the resist roller, or the adjustment of the scanning speed.

Moreover, it may be configured that, after the correction unit 404 stores the displacement amounts for every sheet feed cassette in the predetermined storage device, the print pattern forming unit 402 forms on one sheet the comparative print patterns corresponding to the sheet feed cassettes for every sheet feed cassette. Hereby, the displacement amounts of the print patterns for every sheet feed are corrected and printed on one sheet. The user checks the printed sheet and can easily confirm whether or not the displacement amounts are corrected appropriately. It may be configured that, after the displacement amounts are recalculated using the printed sheet, the print positions on the sheet are corrected based on the displacement amounts for every comparative print pattern.

In the embodiment of the present disclosure, after the comparative print patterns are printed on one sheet, all the displacement amounts for every comparative print pattern can be calculated in a lump by one time of the image reading operation (or one time operation of reading both sides of the sheet when the comparative print pattern corresponding to the virtual sheet feed cassette is formed on the back of the sheet at the duplex printing). Accordingly, it is possible to reduce the troubles and time of the print position adjustment operation. This print position adjustment must be performed for every multifunction peripheral 100 at the factory shipment, but it is possible to reduce the number of process of the print position adjustment on the production line by employing the present disclosure. Since the comparative print patterns are collected and printed on one sheet, the number of the useless sheets can be reduced.

In the present disclosure, it is configured that the displacement amount calculation unit 403 in the multifunction peripheral 100 automatically calculates the displacement amount of the comparative print patterns corresponding to every sheet feed cassette, but the calculation method of the displacement amounts may be configured by any other method. For instance, the user manually measures the comparative positions of each comparative print pattern using the printed sheet, and inputs the measured comparative positions for every comparative print pattern through the operation unit 102. Upon receipt of the input, the displacement amount calculation unit 403 calculates the displacement amounts for every comparative print pattern by comparing with the reference positions of the reference print patterns.

The present disclosure is explained according to the example that the points of the V-shapes having the different angles Ω1, Ω2, Ω3 . . . are defined as the reference position, but the reference position is not limited to that. For instance, in case of using a cross mark, an intersection may be the reference position. Otherwise, in case of using a L-shaped pattern, a bending point of the pattern may be the reference position.

In the embodiment of the present disclosure, the multifunction peripheral 100 is configured to include each unit, but it may be configured by providing with the storage medium storing the program realizing the respective units. In such configuration, the program is read onto the image forming apparatus, and the image forming apparatus realizes the respective units. In this case, the program read from the storage medium can provide with the same effect as the present disclosure. In addition, it is possible to provide with the method for storing the steps executed by each unit in the hard disk.

What is claimed is:

1. An image forming apparatus comprising:
a plurality of sheet feed cassettes;
a print pattern forming unit for forming plural comparative print patterns on a sheet by reference print patterns corresponding to every sheet feed cassette associated with different reference positions for every sheet feed cassette;
a displacement amount calculation unit for reading the comparative print patterns on the sheet, and calculating displacement amounts between the reference positions and comparative positions of the read comparative print patterns corresponding to the reference positions; and
a correction unit for correcting the print position of the sheet conveyed from the sheet feed cassette based on the displacement amount for every sheet feed cassette.

2. The image forming apparatus according to claim 1, wherein
the print pattern forming unit radially prints the comparative print patterns corresponding to every sheet feed cassette on one sheet.

3. The image forming apparatus according to claim 1, wherein
the reference print patterns and the comparative print patterns are in V-shape having specific angles, and opening directions of the angle based on a sheet conveyance direction correspond to every sheet feed cassette.

4. The image forming apparatus according to claim 1, wherein
when the print pattern forming unit forms a comparative print pattern for a specific sheet feed cassette on one sheet and then forms the other comparative print pattern for the other sheet feed cassette on the same sheet,
the print pattern forming units reversely conveys the sheet to the other sheet feed cassette and stores the sheet in the other cassette, and conveys the sheet from the other cassette, and forms the other comparative print pattern on the sheet.

5. The image forming apparatus according to claim 1, wherein
when the print pattern forming unit forms a comparative print pattern for a specific sheet feed cassette on one sheet and then forms the other comparative print pattern for the other sheet feed cassette on the sheet,
the print pattern forming units ejects the sheet to a sheet receiving tray, displays an instruction to place the ejected sheet to the other sheet feed cassette, and detects the sheet is placed in the other cassette and then forms the other comparative print pattern on the sheet.

6. The image forming apparatus according to claim 1, wherein
the print pattern forming unit selects a V-shaped reference print pattern of a specific angle with respect to the sheet conveyance direction of the sheet corresponding to a specific sheet feed cassette among the reference print patterns stored in a storage device, and forms the comparative print pattern by printing the selected reference print pattern on the sheet, and
the displacement amount calculation unit calculates the comparative position of the specific comparative print pattern of the read plural comparative print patterns, and determines the reference print patter having the approximately same angle as the direction of the opening angle of the comparative print pattern, and calculates, as the displacement amount of the comparative print pattern, a difference when the reference position of the determined reference print pattern is subtracted from the calculated comparative position of the comparative print pattern.

7. The image forming apparatus according to claim 1, wherein
when the image forming apparatus forms a toner image on the sheet conveyed from a specific sheet feed cassette, the correction unit corrects the print position of the sheet by shifting an image forming position of the toner image by the displacement amount of the sheet feed cassette in a reverse direction.

8. A method of adjusting a print position comprising steps of:
a print pattern forming step for forming plural comparative print patterns on a sheet by reference print patterns corresponding to every sheet feed cassette associated with different reference positions for every sheet feed cassette;
a displacement amount calculation step for reading the comparative print patterns on the sheet, and calculating displacement amounts between the reference positions and comparative positions of the read comparative print patterns corresponding to the reference positions; and
a correction step for correcting the print position of the sheet conveyed from the sheet feed cassette based on the displacement amount for every sheet feed cassette.
